(19) United States
(12) Patent Application Publication
(10) Pub. No.: US 2024/0028793 A1
(43) Pub. Date: Jan. 25, 2024

(54) METHOD OF GROUT SELECTION FOR LONG TERM INTEGRITY OF ANCHORING PILES

(71) Applicant: Halliburton Energy Services, Inc., Houston, TX (US)

(72) Inventors: Richard Frank VARGO, JR., Houston, TX (US); Walmy Cuello JIMENEZ, Houston, TX (US); Siva Rama Krishna JANDHYALA, Houston, TX (US)

(21) Appl. No.: 17/956,033

(22) Filed: Sep. 29, 2022

Related U.S. Application Data
(60) Provisional application No. 63/391,236, filed on Jul. 21, 2022.

(51) Int. Cl. G06F 30/23; G06F 30/13; E02D 5/54

(52) U.S. Cl. CPC G06F 30/23; G06F 30/13; E02D 5/54; G06F 2111/10

(57) ABSTRACT

A method of designing a grout material for an anchoring pile system based on the analysis of a stress state of the anchoring pile constructed into a subterranean formation. An advisory process can utilize a model to produce a numerical model of the anchoring pile, a model to determine the operational loads, a model to determine the grout material, and a model to determine the stress state of the grout interfaces. The group of models can determine a probability of failure of the grout material, a probability of failure of a grout interface, and a predicted lifespan of the grout materials.

### CROSS-REFERENCE TO RELATED APPLICATIONS

None.

### BACKGROUND

Anchoring piles are frequently installed in onshore and offshore environments to provide an anchoring system for large loads, for example to provide suitable foundations or anchors for windfarms in both land and offshore locations. An onshore location can intersect or transit a sensitive area such as an aquafer or water table. Offshore structures, e.g., offshore oil and gas platforms, can utilize specialized construction process including specialized vessels during the construction process.

In recent years there has been growing activity in the development of renewable energy devices, for example, windfarms. Such devices can be subjected to large dynamic loads during operation and typically require a pile system to be anchored to a subterranean formation to provide of foundation support. The loading on the windfarm can include compression loading, tension loading, and transverse loading that results in a bending moment.

The pile system may include a pile, a sleeve, and a grout designed to withstand the dynamic loading. The design of the pile can depend on the stresses from the dynamic loading and the type of subterranean formation. The type of sleeve can depend on the depth of the formation, e.g., the location of hard rock. The selection of the grout can depend on the pile, the type of sleeve, the formation, and stresses applied to the pile system. A method of selecting the grout for the pile system is desirable.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a cut-away illustration of a pile system according to an embodiment of the disclosure.

FIG. 2A is a logical flow diagram depicting a method for grout selection for a pile system according to an embodiment of the disclosure.

FIG. 2B-2E are illustrations of a grout interface according to an embodiment of the disclosure.

FIG. 2F is a table of grout mechanical properties according to an embodiment of the disclosure.

FIG. 2G is a table of forces applied to an anchoring pile system according to an embodiment of the disclosure.

FIG. 2H is an illustration of stress distribution along a grout interface according to an embodiment of the disclosure.

FIG. 3 is a logical flow diagram depicting a method for grout selection for a pile system according to another embodiment of the disclosure.

FIG. 4 is an illustration of a communication system according to an embodiment of the disclosure.

FIG. 5 is a block diagram of a computer system suitable for implementing one or more embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Anchoring piles can provide an anchoring structure for large loads, both in offshore and land applications (e.g., windfarms). An anchoring pile can be constructed by installing a sleeve into (or above) the ground, drilling a borehole into a formation, placing a tension structure that straddles a portion of the sleeve and the borehole, filling the annuli between tension structure-borehole and the tension structure-sleeve with same or different grout material, and connecting the operational loads to a load point coupled to the sleeve. Each step of the construction process can have an effect on the other steps of the construction process. For example, the grout material between subterranean formation and the tension structure can provide the necessary support and bonding between the pile (e.g., tension structure) and formation. Such a grout can be called a subterranean grout. In another scenario, the grout material located between the sleeve and tension structure can provide necessary support and bonding to transfer the stress from the sleeve to the grout in the sleeve-tension structure annulus, to tension structure, to the grout between in the tension structure-formation annulus, to the formation, or combinations thereof. The grout between sleeve-tension structure can be either a subterranean grout or a surface grout or both depending on the location of sleeve vis-A-vis subterranean surface. A structured design process for combining the complexity of the operational loads, the variety of subterranean formations, and the various grout materials is desirable.

In some embodiments, a design method can utilize multiple models to tailor a blend of grout material(s) to withstand the various operational loads. The method can determine a subterranean grout or a combination of subterranean and surface grouts that influence each other. In some embodiments, the design method can model the distribution of loads between multiple grouts.

In some embodiments, a grout blend can be designed based on predicted grout system stresses. The design process can access a database of drilling operation data comprising geologic formation composition, porosity, depth, temperature, mechanical properties, and other environmental data to model the stress state of a grout blend based on predicted compression, tension and transverse loading of the pile system.

Disclosed herein is a method of evaluating a current stress state in an anchoring pile system. A model group can be used to determine the load point values from operational loads, the formation properties of the subterranean formation the borehole is drilled into, a stress state of the grout material and multiple grout interfaces. The model group can output a probability of grout material failure at a grout interface or in the bulk of the grout. The model group can output a job design (e.g., properties for one or more grouts) based on the model group simulations exceeding a threshold value of probability of failure of grout material or the interfaces of grout material with surrounding materials.

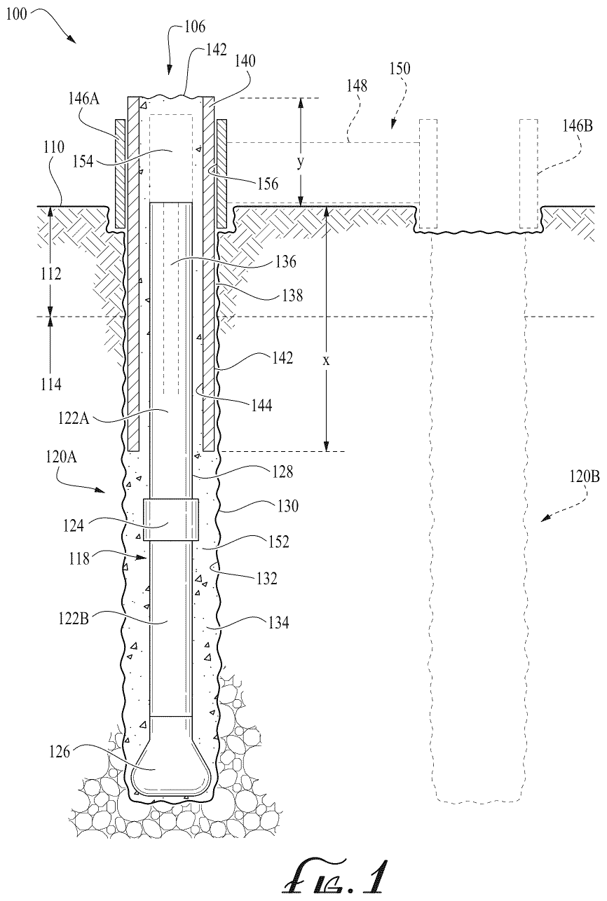

Turning now to FIG. 1, illustrated is an anchoring pile environment 100 that can be utilized as a foundation to support structures that exert large loads into the foundation. In some embodiments, a borehole 130 can be drilled into the subterranean formation 114 using any suitable drilling technique and can extend in a substantially vertical direction away from the earth's surface 110. The surface 110 can be at ground level elevation when the borehole 130 is located on land. The surface 110 can be a seabed located underwater when the borehole is located offshore. The borehole 130 can be drilled through a first formation 112 into a subterranean formation 114. The first formation 112 can extend a portion of the measured depth of the borehole 130 and can be formed of a first layer of unconsolidated sediment. The subterranean formation 114 can be a hard rock formation with geologic properties different from the first formation 112.

In some embodiments, the anchoring pile 120 comprises a sleeve 140, a tension structure 118, and a volume of grout 134. The sleeve 140 can be a generally tubular member with an outer surface 142 and an inner surface 144. A portion of the sleeve 140 can extend a distance X into the borehole 130 measured from the surface 110. A portion of the sleeve 140 can extend a distance Y above the surface 110.

In some embodiments, the tension structure 118 can be a drilling assembly comprising at least one drill rod 122 and a drilling mechanism 126. The drill rod 122 can be a generally cylindrical shape with an outer surface 128 and an inner passage 136. Although the shape is described as cylindrical, it is understood that the cross-sectional shape can be any geometric shape, for example, a square shape, a pentagon, a hexagon, an octagon, or shape with any number of sides. The inner passage 136 can be configured for a flow of fluids, for example, a drilling mud. The drilling mechanism 126 can be an auger or any drilling bit suitable for subterranean formations, such as a rolling cutter bit, a fixed cutter bit, or a hybrid combination of rolling and fixed cutter bit. The drilling mechanism 126 can couple to the drilling rod 122. In some embodiments, a coupling can couple the drilling mechanism 126 to the drilling rod 122. The drilling mechanism 126 can include an inner passage for the flow of fluids from the drilling rod 122. In some embodiments, the drilling mechanism 126 can include a number of nozzles for directing drilling fluids out to cool and lubricate the cutting surfaces of the drilling mechanism 126. In some embodiments, the drilling assembly, e.g., tension structure 118, can include two or more drilling rods, e.g., drilling rod 122A and drilling rod 122B, mechanically coupled with a coupling 124. Although two drilling rods are illustrated, it is understood that the drilling assembly, e.g., tension structure 118, can comprise 1, 2, 3, 4, 5, 6, 7, 8, 9, 10, or any number of drilling rods 122 joined or mechanically coupled with couplings 124. In some embodiments, the coupling 124 can be combined with the drilling rod 122, for example, the drilling rod can be box by pin construction so that each drilling rod 122 can mechanically couple to the next, for example, drilling rod 122A can couple with drilling rod 122B. Although the borehole 130 is illustrated as a vertical borehole, it is understood that the borehole 130 can be formed at an angle from a vertical centerline. For example, the borehole 130 can be formed at an angle of 0 degrees (e.g., vertical), 10 degrees, 20 degrees, 30 degrees, or any angle in the range of 0 to 60 degrees.

In some embodiments, the drilling assembly can include a anchoring mechanism 154 coupled to the drilling rod 122. The anchoring mechanism 154 can mechanically couple the drilling assembly, e.g., tension structure 118, to the sleeve 140. The coupling mechanism 154 can include a threaded portion, an anchoring lug, an anchoring assembly, or combinations thereof. The threaded portion of the anchoring mechanism 154 can threadingly couple with an matching threaded portion on the sleeve 140. The anchoring lug of the anchoring mechanism 154 can locate and anchor into a corresponding receptacle on the sleeve 140. The anchoring assembly of the anchoring mechanism 154 comprises a set of slips, also referred to as dogs, with a gripping structure that anchors to the sleeve 140 when urged into contact with the sleeve 140. In some embodiments, the anchoring mechanism 154 can sealingly engage the sleeve 140 to form a seal between the tension structure 118 and the sleeve 140. For example, the anchoring mechanism 154 can include a sealing structure that sealingly engages the outer surface of the anchoring mechanism and/or the outer surface 128 of the drill rod 122 and the inner surface 144 of the sleeve 140. In some embodiments, the anchoring mechanism 154 comprises a valve mechanism that closes off an inner passage that fluidically connects to the inner passage 136 of the drilling rod 122.

In some embodiments, the tension structure 118 comprises a cage like structure formed of bars, e.g. rebar, bend into a round shape or a spiral shape and bound or welded to straight bars, e.g., rebar. The tension structure 118 may be formed of any number of ribs, e.g., round sections, bound to the cage bars, e.g., straight sections, and extend from the bottom of the borehole 130 to the surface 110 or the top of sleeve 140 that extends the distance Y above the surface.

In some embodiments, the grout 134 may fill the borehole 130 from the bottom of the borehole 130 to fill a portion of the sleeve 140. In some embodiments, the grout 134 can fill the sleeve 140 to the top of sleeve 140 that extends the distance Y above the surface. The grout 134 can be a cementitious material that cures or hardens into a solid structure. For example, the grout 134 can be Portland cement or a blend of Portland cement with various additives to tailor the cement for the borehole 130 and/or the borehole environment. For example, retarders or accelerators can be added to the wet grout (uncured grout) to slow down or speed up the curing process. In some embodiments, the grout 134 can be or include a polymer designed for subsea (underwater) environments. In some embodiments, the grout 134 can be cement blend designed to resist saltwater corrosion. In some embodiments, the grout 134 can have additives such as expandable elastomer particles or nanoparticles. In some embodiments, the grout 134 can be a thermosetting resin system.

The grout 134 placed in the annular space 152 between the outer surface 128 of the tension structure 118 and the inner surface 132 of the borehole 130 can cure (harden) to form an anchor pile, also referred to as a pile. The term anchoring pile 120 can refer to the sleeve 140, the tension structure 118, and the grout 134, e.g., a Portland cement or a blend of Portland cement, that has cured or hardened.

In some embodiments, an anchoring template 150 can be used to transfer a load to one or more anchoring piles 120. The anchoring template 150 can comprise a template socket 146 coupled to the anchoring pile 120 via the sleeve 140. The template socket 146 can include at least one load point, e.g., a shackle, that another structure or forces from another structure is attached to, e.g., an anchor cable. Another structure can apply a tension load, a compression load, a transverse load, a bending load or combinations thereof. For example, a floating structure can apply a combination of tension loads and transverse loads via the load point of the template socket 146. In some embodiments, the template socket 146 of the anchoring template 150 can be mechanically coupled to the anchoring pile 120, for example, threadingly connected. In some embodiments, the template socket 146 can be coupled to the anchoring pile 120 with a surface grout 138. The surface grout 138 can be placed between the outer surface 142 of the sleeve 140 and the inner surface 156 of the template socket 146. In some embodiments, the sleeve 140 comprises at least one load point for the operational loads. In some embodiments, the anchoring template 150 can be combined with the sleeve 140. In some embodiments, the anchoring template 150 can mechanically couple with the sleeve 140. In some embodiments, the anchoring template 150 can replace the sleeve 140.

In some embodiments, the anchoring template 150 comprises two or more template sockets 146 joined by a load beam 148. For example, the anchoring template 150 can comprise a first template socket 146A and a second template socket 146B coupled to the load beam 148. An anchoring pile 120 can couple with each template socket 146. For example, a first anchoring pile 120A can couple with a first template socket 146A and a second anchoring pile 120B can couple with a second template socket 146B. The load point of the anchoring template 150 can be coupled to the load beam 148. In some embodiments, the anchoring template 150 can have two or more load points. Although two template sockets 146 are described, it is understood that the anchoring template 150 can comprise 1, 2, 3, 4, 5, 6, 7, 8, 9, or any number of template sockets 146 and load beams 148. The template sockets 146 can be distributed about the anchoring template 150 in a geometric shape or a pattern. For example, the anchoring template 150 can be formed generally in the shape of a triangle by three load beams 148 coupled with the three template sockets 146A-C. Although two anchor piles 120A-B are illustrated oriented in a parallel direction in FIG. 1, it is understood that the anchor piles 120A-B can be angled towards each other to form an acute angle or away from each other to form an obtuse angle. In some embodiments with more than two piles, the anchoring pile 120 can be vertical, angled toward the center of the anchoring template 150, angled away from the center or the anchoring template 150, or any combination thereof.

In some embodiments, the operational loads coupled to a load point can be produced by a windfarm. For example, a wind turbine stationed offshore can couple to a load point of the anchoring pile system 106. The operational loads produced by the wind turbine in the windfarm can include compression loading, tension loading, transverse loading, or combinations thereof. In some embodiments, the wind turbine can be directly coupled to the anchoring pile system 106, for example, the anchoring pile system 106 can be a foundation for the wind turbine. In some embodiments, the wind turbine can be mechanically coupled to the anchoring pile system 106, for example, mechanically coupled via an anchoring cable. In some embodiments, the operational loads produced by the wind farm can be coupled to the anchoring pile system 106 via a socket 146, an anchoring template, or combinations thereof.

The construction process for the anchoring pile 120 can generally be the same for a location on land or offshore. The construction operation can comprise construction equipment suitable for drilling the borehole 130 and pumping equipment suitable for placing the grout 134. The construction equipment and pile materials can be transported to a remote construction location for the construction operation. The design of the anchoring pile 120 and/or template 150 can be transmitted or delivered to the construction operation. In some embodiments, the design of the anchoring pile 120 can be wirelessly transmitted as will be disclosed further herein.

In some embodiments, the sleeve 140 can be driven, e.g., hammered, into the first formation 112 for a distance X from surface. The hammering method to drive the sleeve 140 into the ground is commonly referred to as pile-driving. In some embodiments, the sleeve 140 can be driven through the first formation 112 into the subterranean formation 114. In some embodiments, the sleeve 140 can be installed into a pre-drilled section of the borehole 130 or a portion of the borehole 130. For example, the borehole 130 can be drilled part-way, such as the distance X from surface, and the sleeve 140 can be installed into the portion of the borehole 130 that has been drilled.

In some embodiments, a retractable tubing can be lowered from the drilling equipment to releasably connect to the sleeve 140. In an offshore environment, the retractable tubing is commonly referred to as a riser. The retractable tubing can fluidically connect the sleeve 140 to the drilling equipment to provide a flow path for the drilling fluids to return to the drilling equipment. In an onshore environment, the retractable tubing may be analogous to a bell nipple, wellhead, or combinations thereof.

A drilling assembly, e.g., tension structure 118, comprising the drilling mechanism 126 and at least one drill rod 122 can be lowered through the riser to drill the borehole 130 from surface 110 by a workstring. The workstring can include servicing tubulars coupled together, for example, drill pipe, workover pipe, heavy weight pipe, production tubulars, or coil tubing. The workstring can rotationally and fluidically couple the drilling assembly to the drilling equipment. The drilling operation generally comprises rotating the drilling mechanism 126 with the drilling equipment via the workstring while pumping drilling fluids through workstring to the inner passage 139 of the drill rod 122. The drilling fluid cools the drilling mechanism 126 while returning drill cuttings to the top of the riser. The drilling equipment can include sensors to measure periodic datasets indicative of the drilling operation. The periodic datasets can include measurements from the fluids systems comprising drilling fluid density, fluid rheology, fluid loss, chemical properties, and solids control. The chemical properties of the drilling fluid can be measured and recorded to determine if the drilling fluid is eroding the borehole 130. The solid control can determine the percent of solids in the drilling fluid and an indication of the mineralogy of the formation, e.g., formation 114. The periodic datasets can be transmitted from the construction operation to a design process as will be described further herein. The drilling operation can drill the borehole 130 to the desired depth from surface 110.

In some embodiments, the grout 134 can be pumped down the inner passage 139 of the drill rod 122 and out the drilling mechanism 126 to fill the annular space 152. The grout 134 can fill the borehole 130 and the sleeve 140. In some embodiments, the grout 134 can be placed between the outer surface 142 of the sleeve 140 and the inner surface 132 of the borehole 130.

In some embodiment, the anchoring mechanism 154 can be coupled between the workstring and the drilling assembly. The anchoring mechanism 154 can be activated to mechanically couple the drilling assembly, e.g., tension structure 118, to the inner surface 144 of the sleeve 140. In some embodiments, the anchoring mechanism 154 can sealingly engage the inner surface of the sleeve 140 to form a seal or barrier between the grout material 134 and the environment above the surface 110 (e.g., seawater). In some embodiments, the anchoring mechanism 154 can close or seal the inner passage 136 of the drill rod 122 of the drilling assembly.

In some embodiments, the workstring can be releasably coupled to the drilling assembly, e.g., drill rod 122A, via the anchoring mechanism 154. The workstring can release or decouple from the anchoring mechanism 154 and be retrieved by the drilling equipment. In some embodiments, the workstring can be releasably coupled to the drilling rod 122 of the drilling assembly. The workstring can release or decouple from the drilling assembly and be retrieved by the drilling equipment.

In some embodiments, a surface grout 138 can be placed between the sleeve 140 and the template socket 146. The surface grout 138 can bond to the inner surface 156 of the template socket 146 and the outer surface 142 of the sleeve 140.

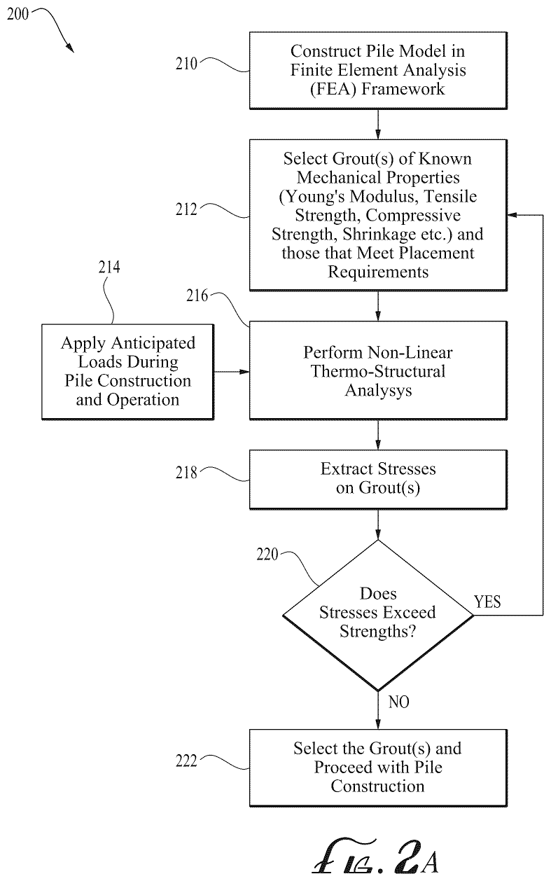

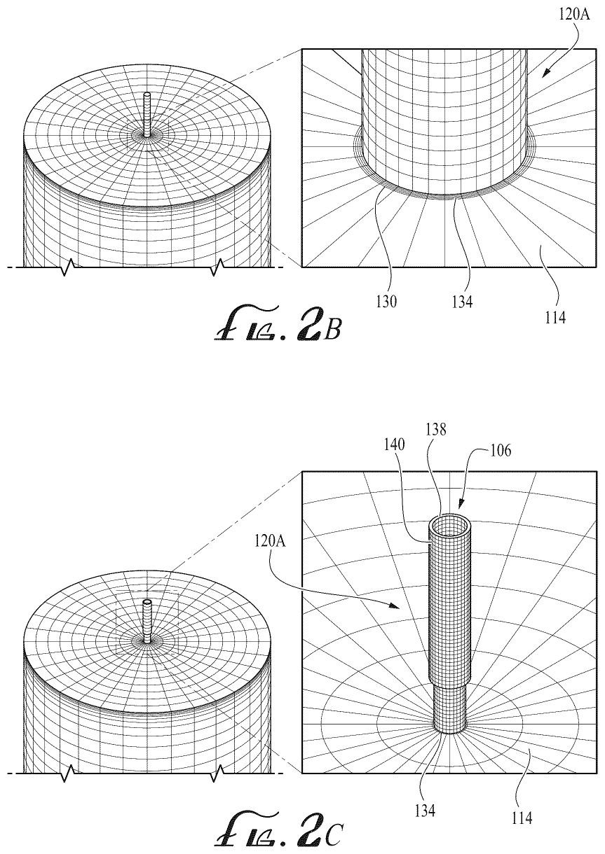

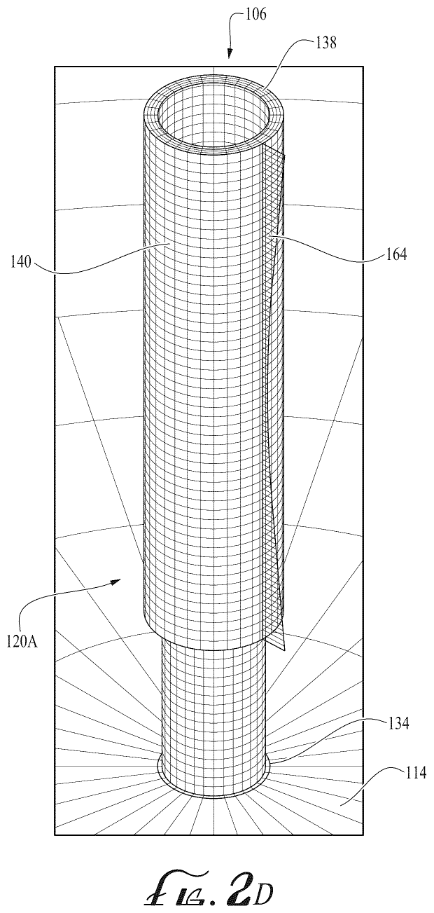

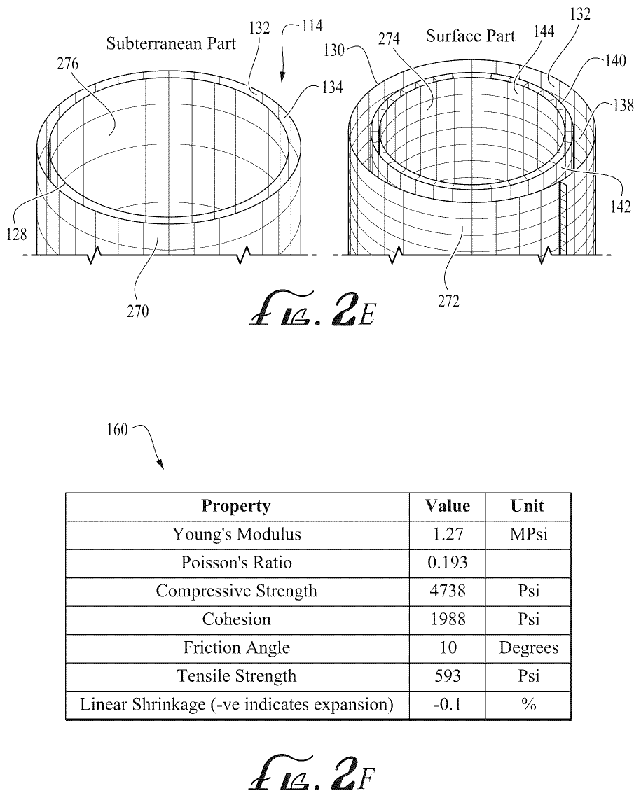

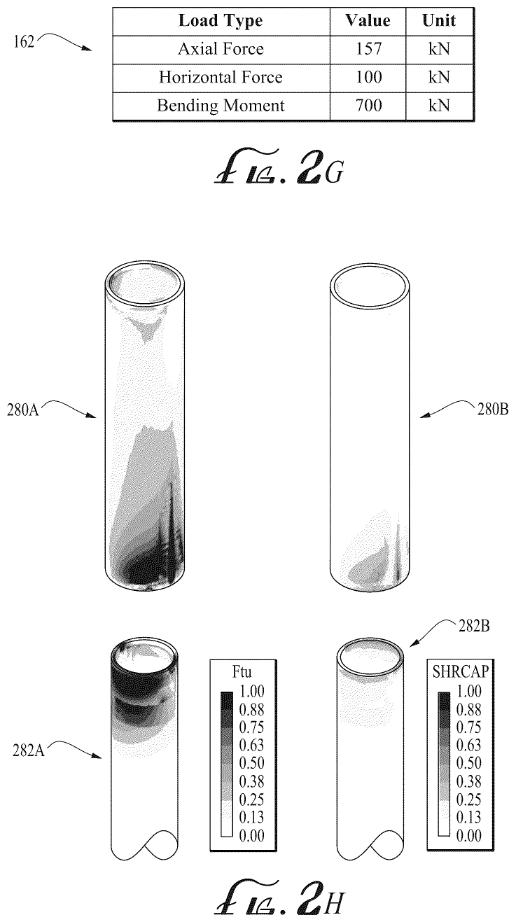

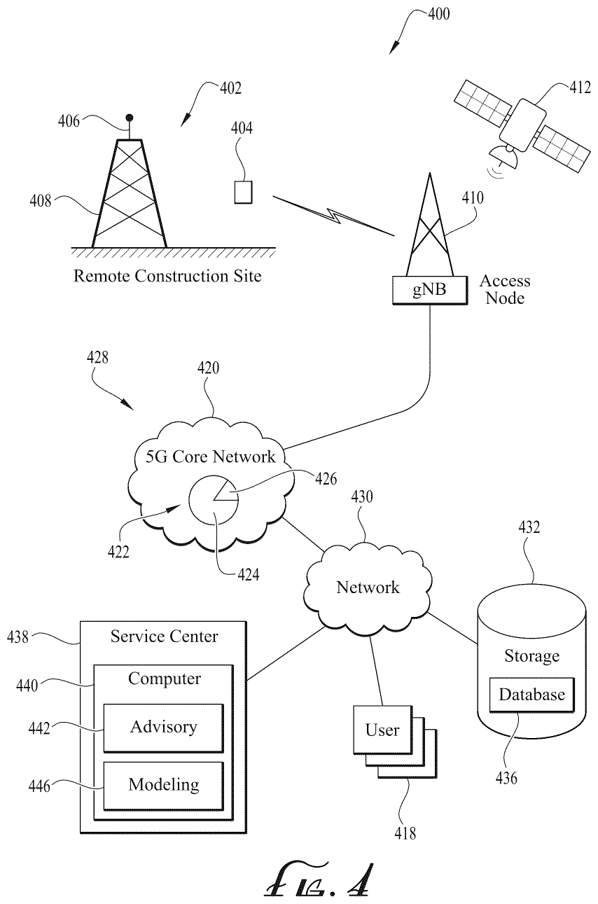

The life span of the anchoring pile 120 of FIG. 1 can depend on designing the pile to withstand the complex stresses applied during its operational life. The strength of the structure can depend on the size and properties of the anchoring pile system 106. For example, the anchoring pile system 106 can include the dimensions of the borehole 130, the properties of the formation 114, the design of the tension structure 118, and the mechanical properties of at least one grout, e.g., grout 134. A process for designing the anchoring pile 120 and/or the anchoring pile system 106 to meet or exceed a design threshold value can comprise at least one model. Turning now to FIG. 2A with reference to FIG. 4, a method of evaluating a stress state of a anchoring pile 120 with an advisory process is illustrated as a logic block diagram. In some embodiments, an advisory process 442 of FIG. 4 can access at least one model of a model group 446 to determine a stress state of the anchoring pile, e.g., anchoring pile 120 of FIG. 1. The model group 446 may include a finite element analysis (FEA) model, a computational fluid dynamics (CFD) model, a rock mechanical model, and a cement mechanical model. The advisory process 442 may determine the stress state of the anchoring pile, e.g., anchoring pile 120, with the results of at least one model from the model group 446, e.g., the FEA model.

The method, e.g., design process 200, comprises the following steps of a design process executing on a computer system, e.g., computer system 440 of FIG. 4. At step 210, the design process can construct a numerical model, e.g., FEA model, of the anchoring pile system, e.g., anchoring pile system 106 of FIG. 1. In some embodiments, design process can retrieve and input the dimensions for the borehole 130, the tension structure 118, the sleeve 140, and the grout 134 from a database 436 on a storage computer 432 into an FEA model (also referred to as an FEA process). The FEA model can construct a numerical model of the anchor pile system 166 comprising the size and depth the borehole 130, the size and depth of the sleeve 140, the size and type of the tension structure 118, the mechanical properties of the cured grout 134, and the volume of grout 134. A grout interface can be defined as a surface area or surface location that allows for debonding and sliding of different materials depending on the level of Coulomb friction, for example, an approximation of the dry frictional forces opposing tangential motion, between the respective surfaces. An example of the locations of various grout interfaces are shown in FIG. 2E, a first grout interface 270 can be located between the inner surface 132 of the formation 114 and the grout 134. A second grout interface 272 can be located along the outer surface 142 of the sleeve 140 and the inner surface 132 of the borehole 130 and the grout 134 or grout 138. A third grout interface 274 can be located along the inner surface 144 of the sleeve 140 and the grout 134 or grout 138. A fourth grout interface 276 can be located along the outer surface 128 of the tension structure 118 and the grout 134. Another example of a grout interface within the anchoring pile system, illustrating one or more of the principles disclosed herein, is shown in FIG. 2B, the numerical model includes an anchoring pile 120 comprising a tension structure 118 (not shown) and a volume of grout 134 placed into the borehole 130 within the formation 114. The numerical model can include a first grout interface 270 between the grout 134 and the inner surface 132 of the borehole 130. In this example, the operational loads applied to the anchoring pile 120 can be applied to the outer surface 142. In still another example of a grout interface is shown in FIG. 2C, the anchoring pile system 106 comprises a tension structure 118 (not shown), a volume of two grouts, e.g., grout 134 and grout 138, and the sleeve 140. The numerical model can include the first grout interface previously described along with a second grout interface 272 located between the outer surface 142 of the sleeve 140 and the inner surface 132 of the borehole 130. In this example, the operational loads can be applied to the sleeve 140.

In some embodiments, the inputs into the FEA model comprises the data for the sleeve 140, the tension structure 118, and the material properties of the grout 134. The FEA model can retrieve the inputs from a database 436 on a storage computer 432. In some embodiments, the dimensions for the borehole 130 can comprise periodic datasets from sensors on drilling equipment located at a remote construction site, for example, remote construction site 402 of FIG. 4. For example, the size of the drilling mechanism 126 can determine the inner diameter of the borehole 130 and the periodic datasets from a drilling operation at the remote construction site 402 can include the drilling depth measured from surface 110. The periodic datasets can include fluid datasets comprising the fluid properties, the formation properties, and the pore strength of the formation 114. In some embodiments, the formation properties, e.g., mineralogy, of the formation 114 can be determined from the rate of penetration, the torque values, and the cuttings returned from surface. In some embodiments, the design process can retrieve the periodic datasets from a drilling operation at the remote construction site 402. In some embodiments, the drilling operation at the remote construction site 402 can transmit the periodic datasets to the design process via wireless communication as will be described further herein.

At step 212, the design process can model at least one grout 134 selected from a database of available grout blends. In some embodiments, the mechanical properties of various grout blends can be stored in a database, e.g., database 436. The design process can select a grout 134 that meets or exceeds the placement requirements and the mechanical properties. For example, the design process can select a grout blend with a density value more than the pore pressure of the formation 114 and with mechanical properties that can reduce the combined loading stress below a threshold value. The mechanical properties of the grout 134 can include Young's modulus, Poisson's ratio, compressive strength, cohesion, friction angle, tensile strength, and shrinkage/expansion. For example, a table 160 of mechanical properties of an exemplary grout is shown in FIG. 2F. In some embodiments, the mechanical properties of the grout 134 can be determined or validated by laboratory testing of a sample of the grout blend. Prior knowledge of designing blends can be helpful in the selection of the at least one grout blend. For example, blends that exhibit lower Young's modulus, high tensile and compressive strength, low shrinkage are more likely to withstand the different complex loads exerted on the pile system.

At step 214, a load point model can determine a combined loading applied to the anchoring pile system 106. In some embodiments, the anchoring template 150 can be coupled to one or more anchoring pile systems 106. As previously described, the anchoring template 150 can include a load point and in some scenarios, the load point can be centrally located. For example, as shown in FIG. 2D, the sleeve 140 can be connected to a load point and, in the example shown, the loads can be applied along the length of the sleeve 140 via a loading edge 164. The load point model can determine a static and/or dynamic combined loading from the operational loads that can be any combination of tension, compression, and side loading. For example, a table 162 of structural loads that can be applied to the anchor pile system 106 is shown in FIG. 2G. The FEA analysis can distribute the forces from the load point model to the one or more template sockets 146. The template sockets 146 can transfer the distributed load to the anchoring pile system 106 via the sleeve 140.

At step 216, the design process can determine the resultant stresses on the anchoring pile system 106 in response to the combined loading. In some embodiments, the design process can utilize a stress model to determine a resultant stress state from an initial loading on the wet grout during the curing process. For example, the stress model can determine the effect of gravity loads, e.g., the weight of the materials and the forces of a water column (for sub-sea applications), on the curing process. The stress model can determine the stresses applied to the grout 134 from the strain loads due to the shrinkage or expansion of the wet grout during the curing process. The anchoring pile system 106 can develop an initial stress state from the strain loads as a result of the curing process. The initial stress state can be transferred to the connecting materials, e.g., the tension structure 118. The design process can retrieve the operational loads from step 214 and apply the loads to the anchoring pile system 106. Stresses and deformations are the fundamental outputs from the analysis of the applied operational loads. In an example, the response of one grout, e.g., grout 134, can be dependent on the existence of a second grout, e.g., grout 138. Thus, the operational load applied to the sleeve 140 via the template socket 146 edge can be distributed to both the grouts, e.g., grout 134 and grout 138, depending on the relative dimensions, stiffness and boundary conditions surrounding each material, e.g., each grout. In some embodiments, the design process can determine the resultant stresses with at least two grouts, e.g., grout 134 and grout 138. The nature of the loading, e.g., distributing the combined loading, in a scenario of at least two grouts can be non-linear. For example, a load applied on the sleeve 140 can generate deformations, and thus stresses, in the surface grout, e.g. grout 138. The surface grout, e.g., grout 138, can transfer part of the resultant deformations to the anchoring pile system 106, which in turn will transfer the stress to the subterranean grout, e.g., grout 134, below the surface and the rock. Thus, stress state in a first grout, e.g., grout 138, will govern the stress state in a second grout, e.g., grout 134. The design process can utilize a non-linear analysis to simultaneously determine a response, e.g., stress and strain, of the anchoring pile system 106.

At step 218, the stresses applied to the grout, e.g., grout 134, can be evaluated. In some embodiments, a probability of failure of the anchoring pile system 106 can be determined from the resultant stresses from the applied operational loads. In some embodiments, the design process can determine a probability of failure of a portion of the anchoring pile system 106, for example, the grout 134. The resultant stresses applied to the anchoring pile system 106 can be scaled with the strength of grout, e.g., grout 134, to determine a probability of failure (i.e., loss of mechanical integrity). The probability of failure can be a scale with a range of 0 to 1, wherein 0 indicates no risk of failure and 1 indicates the onset of the failure of the grout, e.g., grout 134. The probability of failure of the grout material, e.g., grout 134, can be evaluated with applied tensile force, compressive force, transverse force, or combinations thereof and can include a probability of debonding between the various grout interfaces. An example of the analysis of the resultant stresses of the grout is illustrated in FIG. 2H. In this example, the risk of failure in tension (left side) and compression (right side) is evaluated with the range of 0 to 1. The top section 280 comprises a sleeve (not shown), e.g., sleeve 140, with a volume of surface grout, e.g., grout 138. The bottom section 282 comprises the tension structure 118 (not shown), the formation (not shown), with a volume of subterranean grout, e.g., grout 134, in the annulus. Although the top section 280 and bottom section 282 are illustrated with a separation, it is understood that the separation is for clarity and that the two sections can be a continuous assembly (as shown in FIG. 1). On the left hand portion of the example shown, top section 280A and bottom section 282A are placed in tension. The analysis is indicative of a probability of failure (a user defined rating, for example, between 0.88 to 1.00) for a portion of both the top section 280A and the bottom section 282A. On the right hand portion of the example shown, upper section 280B and bottom section 282B are placed in shear. The analysis shows a low probability of failure of the upper section 280B with a probability of 0.63 to 0.50 within a smaller portion of the upper section 280B.

At step 220, the design process can determine if the stresses from the applied loads exceeds the material strength of the grout, e.g., grout 134. In some embodiments, the analysis of the stress level of the grout can determine a portion of the grout with stresses greater than the material strength and a portion of the grout with stresses lower than the material strength of the grout. The design process can determine if the portion, e.g. length, of the grout with stresses lower than the material strength is sufficient to support the anchoring pile system 106 for the lifecycle of the anchoring pile system 106. This determination can include safety factors based on fatigue failure and variability of the design inputs from sensor datasets, e.g., the formation properties. If the design process determines that the stresses exceed the strength of the grout, the design process can return to step 212.

At step 222, the design process can output the pile design of the anchoring pile system 106. The pile design can comprise the volume and properties of one or more grouts, e.g., grout 134 and grout 138, the sleeve 140, and the size the of the borehole 130. The pile design can be stored in the database 436 of the storage computer 432 or transmitted to the drilling operation at the remote construction site 402 as will be described further herein.

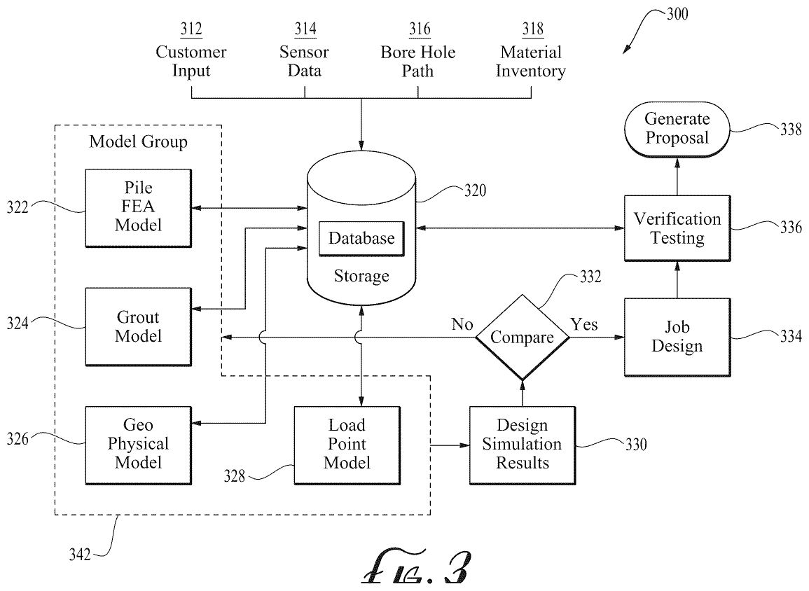

The design process can utilize a model group to determine the pile design and the stress levels of the pile design. A model within the model group can determine a portion of the design process independently or with coordination of the other models within the model group. The design process can begin with any one of the models and end with another model. The design process can iterate a solution for each model or with any combination of models. Turning now to FIG. 3, an anchoring pile system design process 300 is illustrated with a logical flow diagram. The anchoring pile system design process 300 can be an embodiment of the design process 200. In some embodiments, a model group 342 comprises at least one of a pile FEA model 322 i.e. the geometry, a grout material model 324 to describe the mechanical response and failure of grout in tension, compression etc., a geophysical model 326 to describe the mechanical response of formation, and a load point model 328 to describe the nature of loads. Although four models are illustrated, it is understood that two or more models, for example the grout material model 324 and the geophysical model 326, can be combined into a single model. Each model of the model group 342 can be communicatively connected to a database on a storage device 320. The storage device 320 can be an embodiment of storage computer 432 in FIG. 4.

In some embodiments, the inputs for the design process 300 can be inputted into the database on the storage device 320. The inputs can include an anchor pile dataset comprising customer input 312, sensor data 314, a borehole path 316 and a materials inventory 318. The customer input 312 can include at least one design objective. For example, the design objective can be a combined load applied to the anchoring pile system 106. The sensor data 314 can include the periodic datasets from the drilling operation at the remote construction site 402 comprising mud system datasets, a mud report, and periodic datasets indexed to drilling depth of circulation pressure, density, and mud rheology. The borehole path 316 can comprise the borehole trajectory (e.g., inclination), and a description of the borehole environment by depth measurements, e.g., pressure and temperature at a measured depth. The materials inventory 318 can include an inventory of tubulars, e.g., the sleeve 140, an inventory of tension structure 118, an inventory of grout blends, an inventory of chemicals, or combinations thereof. The anchor pile dataset or portions of the anchor pile dataset can be retrieved from a remote data storage location, a remote construction site, inputted by other methods, for example, by an engineer, or combinations thereof.

In some embodiments, a portion of the anchor pile dataset can be received from a construction operation at a remote construction site. For example, during the drilling operation to drill the borehole 130 the drilling operation can transmit real-time data to the design process or to the database within the storage device 320. The term real-time data is defined as drilling data that is available without delay. The real-time data can include sensor data 314, e.g., periodic datasets from the drilling operation, and the borehole path 316, e.g., the borehole trajectory. The design process 300 can iterate the design simulation results received from the model group 342 in response to retrieving real-time data from the database and/or receiving real-time data from the remote construction site.

The design process 300 can begin with any of the models in the model group 342, for example, the pile FEA model 322 of the model group 342. The pile FEA model 322 can retrieve an anchor pile dataset comprising customer input 312, sensor data 314, a borehole path 316, from the database. The customer input 312 can include at least one design objective. For example, the design objective can be a combined load applied to the anchoring pile system 106. The sensor data 314 can include the periodic datasets from the drilling operation at the remote construction site 402 comprising mud system datasets, a mud report, and periodic datasets indexed to drilling depth of circulation pressure, density, and mud rheology. The borehole path 316 can comprise the borehole trajectory (e.g., inclination), and a description of the borehole environment by depth measurements, e.g., pressure and temperature at a measured depth. The materials inventory 318 can include an inventory of tubulars, e.g., the sleeve 140, an inventory of tension structure 118, or combinations thereof. Although the model is described as retrieving the borehole data from the database, it is understood that a portion of the borehole data may be inputted by other methods, for example, by an engineer. As previously described, the pile FEA model 322 can retrieve the dimensions for the borehole 130, the tension structure 118, the sleeve 140, and the grout 134 from a database on a storage device 320. The pile FEA model 322 can construct a numerical model of the anchor pile system 166 comprising the size and depth the borehole 130, the size and depth of the sleeve 140, the size and type of the tension structure 118, and the volume of grout 134. The design process 300 can utilize the output of the pile FEA model 322, e.g., the numerical model, as one of the threshold values for the grout material model 324 and/or the load point model 328 as will be described herein.

The output of the pile FEA model 322 can be an input into another model within the model group 342, for example, the grout material model 324. In some embodiments, the grout material model 324 can retrieve the grout dataset including the materials inventory 318 to simulate the stress state of the cured grout. The materials inventory 318 can include an inventory of grout blends, an inventory of chemicals, or combinations thereof. The term anchoring barrier may refer to Portland cement, a blend of Portland cement, a polymer, or combinations thereof that has cured or hardened. The grout material model 324 can determine a stress state of the anchoring barrier and the grout interface, e.g., the first grout interface, from the inputs and the output of the load point model 328. The output of the grout material model 324 can include a set of design simulation results with a probability value of the failure of the grout or a portion of the grout. For example, the grout material model 324 may generate a probability of a grout within the third interface exceeding a future stress state based on the output of the load point model and the grout within the borehole path, e.g., borehole 130.

The output of the grout material model 324 may be an input into another model within the model group 342, for example, the geophysical model 326. The geophysical model 326 may determine a stress limit for the formation 114. The geophysical model 326 can describe how mechanical properties evolve as a function of composition of the rock, e.g., formation 114. For example, a simple form of such model, e.g., grout material model 324, comprises volume averages of mechanical properties of pure species. The rock mechanical model can determine other elastic properties of the formation 114 based on volumetric averaging techniques. The model can determine the strength of the rock using empirical equations or inputting the results of laboratory tests using cores or cuttings. The geophysical model 326 can determine the grout 134 compatibility with the formation 114, the drilling fluids, the wellbore temperature, the wellbore pressure, or combinations thereof. The geophysical model 326 can determine the stress limit of the second grout interface located between the inner surface 132 of the formation 114 and the grout 134. The output from the geophysical model 326 of the design process 300 can comprise a probability of a grout blend achieving a job objective based on simulation results of the geophysical model 326.

The output of the geophysical model 326 may be an input into another model within the model group 342, for example, the load point model 328. The load point model 328 can determine the distribution of the operational load applied to each anchoring pile system 106 via the template socket 146 of the anchoring template 150. The output of the load point model 328 can include a static value and/or a dynamic value.

Although the design process 300 is described as a linear process that steps from model to model, for example, pile FEA model 322 to grout material model 324, it is understood that the design process 300 can be a non-linear method that iteratively modifies at least one input to achieve one or more objectives. For example, the design process 300 may step from load point model 328 back to the geophysical model 326 to iterate the job design 234, e.g., the grout blend, until the simulation results for both models are below a threshold. In some embodiments, the design process 300 may receive real-time data from a drilling operation. The design process 300 can iteratively modify at least one input to achieve at least one objective in response to receiving real-time data. The design process 300 may iterate one or more inputs to achieve an objective that is not a design objective, for example, to reduce the cost below a threshold value.

At step 332, if the design simulation results 330 from the model group 342 are below a threshold value, the design process 300 may apply a constraint, e.g., a requirement for a lighter density, and iterate an input, e.g., materials inventory 318, and return to the model group 342 for with a revision to the job design. For example, the first grout blend can be iterated to a second grout blend and one or more models can generate a second set of simulation results. The design simulation results 330 can also comprise a probability of achieving the job objective and compared to a threshold value. Each of the models in the model group 342 can have a unique threshold value or a shared threshold value. For example, a shared threshold value can be the stress level of the second grout interface (e.g., grout to formation interface) for the grout material model 324 and the geophysical model 326. Other threshold values may include customer requirements including lifecycle, cost, or combinations thereof. If the set of design simulation results 330 are below a threshold value and the design process 300 has generated more than one revision to the grout blend, e.g., a fifth, sixth, or seventh grout blend, the design process 300 may generate a failure report and notify one or more user devices of the failure report.

A job design 334 may be generated by the design process 300 if the design simulation results 330 are above a threshold value at step 332. The job design 334 may be an embodiment of the anchoring pile environment 100 of FIG. 1. The job design 334 may comprise the tension structure 118, the grout blend, the dimensions of the borehole 130, the sleeve 140, a template 150, or combinations thereof.

At step 336, the design process 300 may generate a verification testing request including the current revision of the grout blend and the stress limits of the anchoring pile system 106. The laboratory verification on the grout blend can include thickening time, fluid loss, mixability, stability of formulation, mechanical properties, and strength. The mechanical properties of the grout blend can include shrinkage, bond strength, gel strength, density, or combinations thereof. The verification testing, e.g., laboratory testing, may be completed consecutively or concurrently to the flow of the design process 300. The results of the verification testing can be transmitted to the database, the storage device 320, or combinations thereof.

At step 338, the design process 300 may generate a construction proposal for the anchoring pile system. The construction proposal may comprise the job design 334.

The modeling group 342 accessed by the design process 300 can be located on a local computer system or on a remote computer system. Turning now to FIG. 4, a data communication system 400 is illustrated. In some embodiments, the data communication system 400 comprises a remote construction site 402, an access node 410 (e.g., cellular site), a mobile carrier network 428, a network 430, a storage computer 432, a service center 438, a plurality of user equipment (UE) 404, and a plurality of user devices 418. A remote construction site 402 can include a drilling operation, e.g., drilling equipment 408, as part of a construction operation for the anchoring pile system 106. The drilling equipment 408 can include a communication device 406 (e.g., transceiver) that can transmit and receive via any suitable communication means (wired or wireless), for example, wirelessly connect to an access node 410 to transmit data (e.g., periodic dataset) to a storage computer 432. The storage computer 432 may also be referred to as a data server, data storage server, or remote server. The storage computer 432 may include a database 436 comprising construction design data. Wireless communication can include various types of radio communication, including cellular, satellite 412, or any other form of long range radio communication. The communication device 406 may communicate over a combination of wireless and wired communication. For example, communication device 406 may wirelessly connect to access node 410 that is communicatively connected to a network 430 via a mobile carrier network 428.

In some embodiments, the communication device 406 on the drilling equipment 408 is communicatively connected to the mobile carrier network 428 that comprises the access node 410, a 5G core network 420, and a portion of the network 430. The communication device 406 may be a radio transceiver connected to a computer system. The computer system may be the unit controller communicatively connected to the drilling equipment, a pumping system, a fluids system, or combinations thereof.

The UE 404 may be a communication device provided to the service personnel. In some embodiments, the UE 404 may be a computer system such as a cell phone, a smartphone, a wearable computer, a smartwatch, a headset computer, a laptop computer, a tablet computer, or a notebook computer. The UE 404 may be a virtual home assistant that provides an interactive service such as a smart speaker, a personal digital assistant, a home video conferencing device, or a home monitoring device. The UE 404 may be an autonomous vehicle or integrated into an autonomous vehicle. For example, the UE 404 may be an autonomous vehicle such as a self-driving vehicle without a driver, a driver assisted, an application that maintains the vehicle on the roadway with no driver interaction, or a driver assist application that adds information, alerts, and some automated operations such as emergency braking. The UE 404 may be the unit controller, e.g., unit controller on a cement pumping unit, or a computer system communicatively connected to the cement pumping unit.

The access node 410 may also be referred to as a cellular site, cell tower, cell site, or, with 5G technology, a gigabit Node B. The access node 410 can establish wireless communication links to the communication device 406 and UE 404 according to a 5G, a long term evolution (LTE), a code division multiple access (CDMA), or a global system for mobile communications (GSM) wireless telecommunication protocol.

The satellite 412 may be part of a network or system of satellites communicatively connected to form a network. The satellite 412 may communicatively connect to the UE 404, the communication device 406, the access node 410, the mobile carrier network 428, the network 430, or combinations thereof. The satellite 412 may communicatively connect to the network 430 independently of the access node 410.

The 5G core network 420 can be communicatively coupled to the access node 410 and provide a mobile communication network via the access node 410. The 5G core network 420 can include a virtual network (e.g., a virtual computer system) in the form of a cloud computing platform. The cloud computing platform can create a virtual network environment from standard hardware such as servers, switches, and storage. The total volume of computing availability 422 of the 5G core network 420 is illustrated by a pie chart with a portion illustrated as a network slice 426 and the remaining computing availability 424. The network slice 426 represents the computing volume available for storage or processing of data. The cloud computing environment is described in more detail further hereinafter. Although the 5G core network 420 is shown communicatively coupled to the access node 410, it is understood that the 5G core network 420 may be communicatively coupled to a plurality of access nodes (e.g., access node 410), one or more mini-data center (MDC) nodes, or a 5G edge site. The 5G edge site may also be referred to as a regional data center (RDC) and can include a virtual network in the form of a cloud computing platform. Although the virtual network is described as created from a cloud computing network, it is understood that the virtual network can be formed from a network function virtualization (NFV). The NFV can create a virtual network environment from standard hardware such as servers, switches, and storage. The NFV is more fully described by ETSI GS NFV 002 v1.2.1 (2014-12).

The network 430 may be one or more private networks, one or more public networks (e.g., the Internet), or a combination thereof. The network 430 can be communicatively coupled to the 5G core network 420 and the cloud network platform.

The service personnel can retrieve a job design with the UE 404 from the database 436 on the storage computer 432. In some embodiments, the UE 404 and the unit controller on the drilling unit can be referred to as a computer system at the remote construction site 402. In some embodiments, the computer system 440 at the service center 438, the user devices 418, the storage computer 432, and the VNF on the network slice 426 can be referred to as a remote computer system. In some embodiments, the service personnel can communicatively connect computer system at the wellsite, e.g., the UE 404, to a remote computer system, e.g., computer system 440 at the service center via the mobile carrier network 428, the network 430, or combinations thereof. For example, the unit controller on the drilling equipment 408 can connect to the storage computer 432 via the mobile carrier network 428 and/or the network 430. In another scenario, the user devices 418 can connect to the UE 404 via the network 430 and/or mobile carrier network 428.

The computer system 440 can be a computer system, a server, a workstation, a laptop, or any type of suitable computer system. The computer system 440 may be an embodiment of the computer system from design process 200 of FIG. 2A and/or the computer system utilized for the design process 300 of FIG. 3. The database 436 on the storage computer 432 can be an embodiment of the database on the storage device 320 of FIG. 3.

An advisory process 442 executing on the computer system 440 at the service center 438 can be communicatively coupled with a model group 446. The model group 446 executing on the computer system 440 can be an embodiment of the model at step 216 on FIG. 2A and/or model group 342 on FIG. 3. The advisory process 442 can be an embodiment of the design process 200 on FIG. 2A and/or the design process 300 on FIG. 3.

In an embodiment, an engineer utilizing a user device 418 can generate a job design, e.g., job design 334, with the design process 300 executing on the computer system 440. The design process 300 can utilize a model group 342, e.g., model group 446 from FIG. 4. The job design, e.g., job design 334, can be stored in the database 436 on the storage computer 432 and/or database on the storage device 320. The job design can be retrieved from a remote computer system, e.g., storage computer 432, by a computer system at the wellsite, e.g., UE 404.

In some embodiments, the advisory process 442, e.g., design process 300 of FIG. 3, executing on a computer system at the wellsite, e.g., UE 404 of FIG. 4, can communicatively connect to a model group, e.g., model group 446, on a remote computer system. For example, the advising process executing on the unit controller of the drilling equipment 408 at the remote construction site 402 can communicatively connect to the model group 446 on the computer system 440 of the service center 438.

In some embodiments, the advisory process 442 can retrieve real-time data from the drilling equipment 408 at the remote construction site 402 via communication device 406. The real-time data can comprise a portion of the inputs into the model group 446. In some embodiments, the real-time data can be transmitted from the remote construction site 402 to the advisory process 442, to the database 436 within the storage computer 432, to the network slice 426, or combinations thereof.

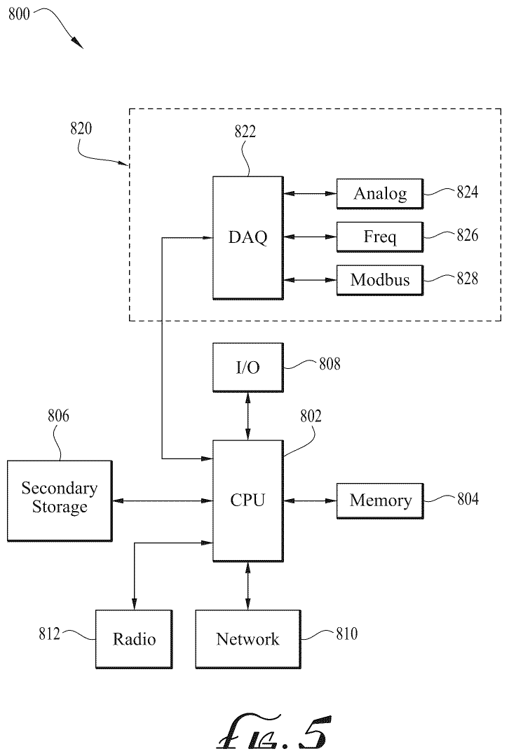

The computer system at the construction site may be a computer system suitable for communication and control of the construction operation including drilling equipment and/or pumping equipment via a unit controller. In some embodiments, the unit controller of the drilling equipment 408 and the UE 404 of FIG. 4 may be an exemplary computer system 800 described in FIG. 5. The computer system located at a remote location may be a computer system suitable for communication and analysis of the design of the anchoring pile system and the construction operation, e.g., a VNF on a network slice. For example, in FIG. 3, the design process 300 can be performed on computer system with the model group 342 executing on the same computer system, a networked computer system, or combinations thereof. The modeling group 342 can be executing on the same unit controller, a networked computer system, a remote computer system, or combinations thereof. In some embodiments, the computer system 440 of FIG. 4 can be an exemplary computer system 800 described in FIG. 5. The computer system located at a remote location can be a storage computer 432 of FIG. 4 and/or the storage device 320 of FIG. 3. In some embodiments, the storage computer 432 and the storage device 320 can be an exemplary computer system 800 described in FIG. 5. Turning now to FIG. 5, a computer system 800 suitable for implementing one or more embodiments of the unit controller, for example, unit controller of the drilling equipment 408, including without limitation any aspect of the computing system associated with the drilling equipment and pumping operation located at the remote construction site 402 of FIG. 4. The computer system 800 may be suitable for implementing one or more embodiments of the storage computer, for example, storage computer 432 of FIG. 4 and storage device 320 of FIG. 3. The computer system 800 may be suitable for implementing one or more embodiments of the computer system in FIG. 4, for example, the computer system 440, cloud computing, the VNF on the network slice 426, a plurality of UE 404, and a plurality of user devices 418. The computer system 800 includes one or more processors 802 (which may be referred to as a central processor unit or CPU) that is in communication with memory 804, secondary storage 806, input output devices 808, and network devices 810. The computer system 800 may continuously monitor the state of the input devices and change the state of the output devices based on a plurality of programmed instructions. The programming instructions may comprise one or more applications retrieved from memory 804 for executing by the processor 802 in non-transitory memory within memory 804. The input output devices may comprise a Human Machine Interface with a display screen and the ability to receive conventional inputs from the service personnel such as push button, touch screen, keyboard, mouse, or any other such device or element that a service personnel may utilize to input a command to the computer system 800. The secondary storage 806 may comprise a solid state memory, a hard drive, or any other type of memory suitable for data storage. The secondary storage 806 may comprise removable memory storage devices such as solid state memory or removable memory media such as magnetic media and optical media, i.e., CD disks. The computer system 800 can communicate with various networks with the network devices 810 comprising wired networks, e.g., Ethernet or fiber optic communication, and short range wireless networks such as Wi-Fi (i.e., IEEE 802.11), Bluetooth, or other low power wireless signals such as ZigBee, Z-Wave, 6LoWPan, Thread, and WiFi-ah. The computer system 800 may include a long range radio transceiver 812 for communicating with mobile network providers.

In some embodiments, the computer system 800 may comprise a DAQ card 814 for communication with one or more sensors. The DAQ card 814 may be a standalone system with a microprocessor, memory, and one or more applications executing in memory. The DAQ card 814, as illustrated, may be a card or a device within the computer system 800. In some embodiments, the DAQ card 814 may be combined with the input output device 808. The DAQ card 814 may receive one or more analog inputs 816, one or more frequency inputs 818, and one or more Modbus inputs 820. For example, the analog input 816 may include a volume sensor, e.g., a tank level sensor. For example, the frequency input 818 may include a flow meter, i.e., a fluid system flowrate sensor. For example, the Modbus input 820 may include a pressure transducer. The DAQ card 814 may convert the signals received via the analog input 816, the frequency input 818, and the Modbus input 820 into the corresponding sensor data. For example, the DAQ card 814 may convert a frequency input 818 from the flowrate sensor into flow rate data measured in gallons per minute.

### ADDITIONAL DISCLOSURE

The following are non-limiting, specific embodiments in accordance and with the present disclosure:

A first embodiment, which is a computer-implemented method of designing an anchoring pile system constructed with a drilling operation, comprising drilling at least one borehole with a drilling assembly; generating a numerical model by a finite element analysis (FEA) process; applying a set of operational loads to the numerical model; applying a set of material properties of a grout material to the numerical model; determining a risk of failure value for at least one grout location of the grout material on the anchoring pile system; iterating the grout material from a first grout material to a second grout material in response to the risk of failure value for the at least one grout location exceeding a risk threshold value; generating an anchoring pile design in response to the risk of failure value exceeding the risk threshold value, and wherein the anchoring pile design comprises a grout blend; and leaving at least a portion of the drilling assembly in the borehole.

A second embodiment, which is the method of the first embodiment, further comprising retrieving, by an advisory process, an anchor pile dataset from a database by an electronic communication method, wherein the anchor pile dataset comprises a plurality of customer input, a plurality of sensor data, a borehole path, a material inventory, or combinations thereof, and wherein the database is on a storage computer.

A third embodiment, which is the method of any of the first and the second embodiments, wherein the numerical model is generated, by an advisory process executing on a computer system, in response to inputting a first set of model inputs into a finite element analysis (FEA) model.

A fourth embodiment, which is the method of and of the first through the third embodiments, wherein the first set of model inputs is selected from an anchor pile dataset.

A fifth embodiment, which is the method of the fourth embodiment, wherein the set of operational loads is generated, by an advisory process, in response to inputting a second set of model inputs into a load point model.

A sixth embodiment, which is the method of any of the first through the fifth embodiments, wherein the second set of model inputs is selected from an anchor pile dataset.

A seventh embodiment, which is the method of any of the first through the sixth embodiments, wherein the grout material is determined, by an advisory process, in response to a set of material properties of the grout material exceeding an operational stress state.

An eighth embodiment, which is the method of any of the first through the seventh embodiments, wherein the set of material properties is selected from an anchor pile dataset.

A ninth embodiment, which is the method of the seventh embodiment, wherein the operational stress state of the grout material is determined by applying the set of operational loads to the numerical model.

A tenth embodiment, which is the method of the first embodiment, wherein the risk of failure value is determined by an advisory process; and wherein the anchor pile design is generated by the advisory process.

An eleventh embodiment, which is the method of the first embodiment, further comprising transporting a grout blend to a construction site with a plurality of pumping equipment in response to an output of the anchoring pile design, wherein the grout blend is included in the anchoring pile design, wherein the plurality of pumping equipment comprises a unit controller; connecting the plurality of pumping equipment to the at least one borehole 130 via the drilling assembly, e.g., tension structure 118, wherein the plurality of pumping equipment is fluidically coupled to the at least one borehole 130 via the drilling assembly 101; beginning a grout placement procedure by the unit controller; retrieving, by the unit controller, one or more datasets of periodic pumping data indicative of a pumping operation; pumping a wet grout blend per a pumping procedure into the borehole via an inner passage 136 of the drilling assembly 101; coupling the drilling assembly 101 to a sleeve 140; disconnecting a workstring from the drilling assembly; and coupling a set of operational loads to the sleeve 140.

A twelfth embodiment, which is the method of the eleventh embodiment, wherein the set of operational loads is produced by a wind turbine.

A thirteenth embodiment, which is the method of any of the first embodiment, wherein the anchoring pile system comprises a drilling assembly 118, e.g., tension structure 118, comprising at least one drill rod 122 and a drilling mechanism 126; a sleeve 140 generally cylindrical in shape with an inner surface 144 and a load point; an anchoring mechanism 154 coupled to the drilling assembly, e.g., tension structure 118, configured to mechanically couple the drilling assembly 188 to the inner surface 144 of the sleeve 140; and a volume of grout material 134 placed within a borehole 130 via an inner passage 136 of the at least one drill rod 122, and wherein the volume

A fourteenth embodiment, which is the method of the thirteenth embodiment, wherein the set of operational loads is directly coupled or indirectly coupled to the load point.

A fifteenth embodiment, which is the method of the fourteenth embodiments, wherein the set of operational loads is produced by a wind turbine.

A sixteenth embodiment, which is a computer-implemented method of designing an anchoring pile system, comprising: retrieving, by a model group executing on a computer system, a portion of an anchoring pile dataset comprising a plurality of customer input and a borehole path; determining, by the model group, a numerical model of the anchoring pile system; determining, by the model group, a set of operational loads applied to the anchoring pile system at a load point; selecting, by an advisory process executing on the computer system, a grout material in response to a set of grout material properties exceeding an operational stress value; receiving, by an advisory process, a set of outputs from the model group, wherein the set of outputs comprises a stress state of the grout material, a stress limit of a grout interface, or combinations thereof; iterating, by the advisory process, a grout material from a first grout material to a second grout material in response to a threshold value exceeding at least one of the set of outputs from the model group; and generating, by the advisory process, a job design in response to the set of outputs exceeding the threshold value.

A seventeenth embodiment, which is the method of the sixteenth embodiment, further comprising inputting, by the advisory process, anchoring pile dataset into a storage computer by an electronic communication method, wherein the anchor pile dataset comprises a plurality of customer input, a plurality of sensor data, a borehole path, a material inventory, or combinations thereof.

An eighteenth embodiment, which is the method of any of the sixteenth and the seventeenth embodiments, further comprising generating, by the model group, the numerical model from a finite element analysis (FEA) model from a first set of model inputs, wherein the first set of model inputs comprises a portion of the anchoring pile dataset.

A nineteenth embodiment, which is the method of the sixteenth embodiment, further comprising generating, by the model group, the set of operational loads by a load point model from a second set of model inputs, wherein the second set of modeling inputs comprises a portion of the anchoring pile dataset.

A twentieth embodiment, which is the method of the sixteenth embodiment, further comprising generating, by the model group, the stress limit of the grout interface by a geophysical model from a third set of model inputs, wherein the grout interface is located between the grout material and a formation and wherein the third set of model inputs comprises a portion of the anchoring pile dataset.

A twenty-first embodiment, which is the method of the sixteenth embodiment, wherein the model group comprising a least one model selected from a group consisting of a pile FEA model, a stress model, a load point model, and a geophysical model.

A twenty-second embodiment, which is the method of the sixteenth embodiment, wherein the set of outputs from the model group comprises a numerical model of the anchoring pile system, a stress state of a grout material, a stress state of a grout interface, a stress limit of an interface located between the grout material and a formation, a distribution of an operational load to the anchoring pile system, a probability value of a failure of the grout or a portion of the grout, or combinations thereof.

A twenty-third embodiment, which is the method of the sixteenth embodiment, wherein the threshold value comprises a probability value for achieving a job objective, a lifecycle value for a grout, a stress state of the anchor pile system, or combinations thereof.

A twenty-fourth embodiment, which is a computer-implemented method of designing an anchoring pile system, comprising retrieving, by a design process executing on a first computer, at least one periodic dataset indicative of drilling a borehole; generating, by the design process, a borehole path comprising a trajectory, a set of formation properties, a description of a borehole environment, or combinations thereof; generating, by the design process, a model input for a model group; determining, by the model group executing on a second computer, i) a stress value for an interface of a grout material to a sleeve, ii) a stress value for a grout material, and iii) a stress value for a grout material to a formation; iterating, by the design process, a grout material in response to a grout stress state exceeding a failure property of at least one of i) the interface of the grout to the sleeve, ii) the grout material, iii) the interface of the grout to a formation, iv) or combination thereof; and generating, by the design process, an anchoring pile design, in response to a threshold of the grout stress state exceeding the failure properties.

A twenty-fifth embodiment, which is the method of the twenty-fourth embodiment, wherein the at least one periodic dataset comprises a dataset selected from the group consisting of fluid systems dataset, borehole path dataset, formation properties dataset, or combination thereof; and wherein the at least one periodic dataset is real-time dataset from a drilling operation.

A twenty-sixth embodiment, which is the method of the twenty-fourth embodiment, further comprising retrieving, by the design process, an anchor pile dataset from a database by an electronic communication method, wherein the anchor pile dataset comprises a plurality of customer input, a plurality of sensor data, a borehole path, a material inventory, or combinations thereof, and wherein the database is on a storage computer.

A twenty-seventh embodiment, which is the method of the twenty-fourth embodiment, further comprising iterating, by the design process, the model input in response to a change in the borehole path in response to receiving a subsequent periodic dataset indicative of a drilling operation.

A twenty-eighth embodiment, which is the method of the twenty-fourth embodiment, further comprising modifying, by the design process, the anchoring pile design in response to a change in the borehole path.

A twenty-ninth embodiment, which is a computer-implemented method of designing anchoring pile system, comprising inputting, by an advisory process executing on a first computer system, a first set of model inputs into a first model executing on a second computer system, wherein the first model is a finite element analysis (FEA) model, and wherein the first set of model inputs is selected from an anchor pile dataset; inputting, by the advisory process, a second set of model inputs into a second model executing on a second computer system, wherein the second model is a load point model, and wherein the second set of model inputs is selected from the anchor pile dataset and a first output from the first model; inputting, by the advisory process, a third set of model inputs into a third model executing on a second computer system, wherein the third model is a grout material model, and wherein the third set of model inputs is selected from the anchor pile dataset, a first output, and a second output from the second model; iterating, by the advisory process, the third set of model inputs in response to a third output not exceeding a stress threshold value; determining, by the advisory process, a lifespan for at least one grout location from an input, wherein the input comprises a set of safety factors, a fourth portion of the anchor pile dataset, the first output, the second output, the third output, or combinations thereof; iterating, by the advisory process, the first set of model inputs in response to the lifespan for the at least one grout location not exceeding a lifespan threshold value; and generating, by the advisory process, an anchoring pile design in response to the lifespan exceeding the lifespan threshold value.

A thirtieth embodiment, which is the method of the twenty-ninth embodiment, further comprising retrieving, by the advisory process, an anchor pile dataset from a database by an electronic communication method, wherein the anchor pile dataset comprises a plurality of customer input, a plurality of sensor data, a borehole path, a material inventory, or combinations thereof, and wherein the database is on a storage computer.

A thirty-first embodiment, which is the method of the thirtieth embodiment, wherein the customer input comprises at least one design objective; wherein the sensor data comprises periodic datasets indicative of a drilling operation; wherein the periodic dataset comprises mud system datasets, a mud report, and periodic datasets indexed to drilling depth of circulation pressure, density, and mud rheology; wherein the borehole path comprises a borehole trajectory, measurements of formation properties, and a description of a borehole environment by depth measurements; and wherein the materials inventory can include an inventory of tubulars, an inventory of grout blends, an inventory of chemicals, an inventory of a tension structure, or combinations thereof.

A thirty-second embodiment, which is the method of the thirtieth embodiment, wherein the storage computer is a data server, computer, virtual computer, VNF, or data storage device located at a wellsite or remote from the wellsite; and wherein the electronic communication method is wired communication, wireless communication selected from one of a cellular node, satellite communication, or short range radio frequency, or a combination thereof.

A thirty-third embodiment, which is the method of the twenty-ninth embodiment, wherein the advisory process iterates a grout blend within the third set of model inputs.

A thirty-fourth embodiment, which is the method of the twenty-ninth embodiment, wherein the first output from the first model comprises a numerical model of the anchoring pile system; wherein the second output from the second model comprises at least one operational force; and wherein the third output from the third model comprises a stress, a strain, a probability of failure, or combinations thereof.

A thirty-fifth embodiment, which is the method of the twenty-ninth embodiment, further comprising transporting a grout blend and a plurality of pumping equipment to a construction site in response to an output of the anchoring pile design, wherein the grout blend is included in the anchoring pile design, wherein the pumping equipment comprise a unit controller; connecting the pumping equipment to a borehole, wherein the pumping equipment is fluidically connected to the borehole; beginning a grout placement procedure by the unit controller; retrieving, by the unit controller, one or more datasets of periodic pumping data indicative of a pumping operation; and pumping a wet grout blend per a pumping procedure into the borehole.

A thirty-sixth embodiment, which is the method of the twenty-ninth embodiment, wherein the lifespan of the at least one grout location comprises a stress state of an intact grout, wherein the intact grout is a portion of the grout within the at least one grout location; and wherein the set of safety factors comprises at least one safety factor for fatigue loading, a measurement error rate, or combinations thereof.

A thirty-seventh embodiment, which is the method of the twenty-ninth embodiment, wherein the first computer system located at a construction site, wherein the second computer system located remote from the construction site, wherein the computer located at the construction site is a computer system, a unit controller, a server, a workstation, a desktop computer, a laptop computer, a tablet computer, a smart phone, or combinations thereof; and the computer remote from the construction site is a computer system, a virtual network function (VNF), a virtual server within a cloud computing environment, a server, a workstation, a desktop computer, a laptop computer, a tablet computer, a smart phone or combinations thereof.

A thirty-eighth embodiment, which is a computer-implemented method of designing an anchoring pile system, comprising retrieving, by a model group executing on a first computer system, a first set of model inputs, wherein the first set of model inputs comprises a portion of an anchoring pile dataset; inputting, by the model group, the first set of model inputs into a first model of the model group; inputting, by the model group, a second set of model inputs into a second model of the model group, wherein the second model is not the first model, wherein the second set of model inputs comprises a first output from the first model, a portion of the anchoring pile dataset, or combinations thereof; inputting, by the model group, a third set of model inputs into a third model of the model group, wherein the third model is not the first or second model, wherein the third set of model inputs comprises a second output from the second model, the first output from the first model, a portion of the anchoring pile dataset, or combinations thereof; inputting, by the model group, a fourth set of model inputs into a fourth model of the model group, wherein the fourth model is the remaining unselected model, wherein the fourth set of model inputs comprises a third output from the third model, the second output from the second model, the first output from the first model, a portion of the anchoring pile dataset, or combinations thereof; receiving, by an advisory process executing on a second computer system, the output from the model group, wherein the output comprises, the first output, the second output, the third output, and a fourth output; iterating, by the advisory process, a portion of the anchoring pile dataset within a storage computer in response to a threshold value exceeding at least one of the output from the model group; and generating, by the advisory process, a job design in response to the outputs of the model group exceeding the threshold value.

A thirty-ninth embodiment, which is the method of the thirty-eighth embodiment, further comprising inputting, by the advisory process, anchoring pile dataset into a storage computer by an electronic communication method, wherein the anchor pile dataset comprises a plurality of customer input, a plurality of sensor data, a borehole path, a material inventory, or combinations thereof.

A fortieth embodiment, which is the method of the thirty-eighth embodiment, wherein the model group comprising a least one model selected from a group consisting of a pile FEA model, a stress model, a load point model, and a geophysical model.

A forty-first embodiment, which is the method of the thirty-eighth embodiment, wherein the output from the model group comprises a numerical model of the anchoring pile system, a stress state of a grout material, a stress state of a grout interface, a stress limit of an interface located between the grout and a formation, a distribution of an operational load to the anchoring pile system, a probability value of a failure of the grout or a portion of the grout, or combinations thereof.

A forty-second embodiment, which is the method of the thirty-eighth embodiment, wherein the threshold value comprises a probability value for achieving a job objective, a lifecycle value for a grout, a stress state of the anchor pile system, or combinations thereof.

A forty-third embodiment, which is the method of the thirty-eighth embodiment, wherein the first computer system located at a construction site; wherein the second computer system located remote from the construction site; wherein the computer located at the construction site is a computer system, a unit controller, a server, a workstation, a desktop computer, a laptop computer, a tablet computer, a smart phone, or combinations thereof; and the computer remote from the construction site is a computer system, a virtual network function (VNF), a virtual server within a cloud computing environment, a server, a workstation, a desktop computer, a laptop computer, a tablet computer, a smart phone or combinations thereof.

A forty-fourth embodiment, which is a method of designing an anchoring pile system, comprising generating, by a finite element analysis (FEA) process, a numerical model of the anchoring pile system; generating an anchoring pile design in response to a risk of failure value of one or more grout materials exceeding a risk threshold value; and wherein the anchoring pile design comprises a grout blend.

A forty-fifth embodiment, which is the method of the forty-fourth embodiment, further comprising retrieving, by the FEA process, from a database a plurality of customer inputs, a plurality of sensor data, a borehole path, a material inventory, or combinations thereof.

A forty-sixth embodiment, which is the method of the forty-fourth embodiment, further comprising applying a set of operational loads to a load point on the numerical model; applying a set of material properties of a grout material to the numerical model; and determining a risk of failure value for at least one grout location of the grout material on the anchoring pile system.

A forty-seventh embodiment, which is the method of the forty-fourth embodiment, further comprising drilling a borehole with a drilling assembly; leaving at least a portion of the drilling assembly in the borehole; and coupling the drilling assembly to a load point.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of constructing an anchoring pile system with a drilling operation, comprising:
drilling at least one borehole with a drilling assembly;
generating a numerical model of the anchoring pile system by a finite element analysis (FEA) process;
applying a set of operational loads to the numerical model;
applying a set of material properties of a grout material to the numerical model;
determining a risk of failure value for at least one grout location of the grout material on the anchoring pile system;
iterating the grout material from a first grout material to a second grout material in response to the risk of failure value for the at least one grout location exceeding a risk threshold value;
generating an anchoring pile design in response to the risk of failure value exceeding the risk threshold value, and wherein the anchoring pile design comprises a grout blend; and
leaving at least a portion of the drilling assembly in the borehole.

2. The method of claim 1, further comprising:
retrieving, by an advisory process, an anchor pile dataset from a database by an electronic communication method, wherein the anchor pile dataset comprises a plurality of customer input, a plurality of sensor data, a borehole path, a material inventory, or combinations thereof, and wherein the database is on a storage computer.

3. The method of claim 1, wherein:
the numerical model is generated, by an advisory process executing on a computer system, in response to inputting a first set of model inputs into a finite element analysis (FEA) model.

4. The method of claim 3, wherein:
the first set of model inputs is selected from an anchor pile dataset.

5. The method of claim 1, wherein:
the set of operational loads is generated, by an advisory process, in response to inputting a second set of model inputs into a load point model.

6. The method of claim 5, wherein:
wherein the second set of model inputs is selected from an anchor pile dataset.

7. The method of claim 1, wherein:
the grout material is determined, by an advisory process, in response to a set of material properties of the grout material exceeding an operational stress state.

8. The method of claim 7, wherein:
wherein the set of material properties is selected from an anchor pile dataset.

9. The method of claim 7, wherein:
the operational stress state of the grout material is determined by applying the set of operational loads to the numerical model.

10. The method of claim 1, further comprising:
transporting a grout blend to a construction site with a plurality of pumping equipment in response to an output of the anchoring pile design, wherein the grout blend is included in the anchoring pile design, wherein the plurality of pumping equipment comprises a unit controller;
connecting the plurality of pumping equipment to the at least one borehole via the drilling assembly, wherein the plurality of pumping equipment is fluidically coupled to the at least one borehole via the drilling assembly;
beginning a grout placement procedure by the unit controller;
retrieving, by the unit controller, one or more datasets of periodic pumping data indicative of a pumping operation;
pumping a wet grout blend per a pumping procedure into the borehole via an inner passage of the drilling assembly;
coupling the drilling assembly to a sleeve;
disconnecting a workstring from the drilling assembly; and
coupling a set of operational loads to the sleeve.

11. A method of designing an anchoring pile system, comprising:
inputting, by a model group executing on a computer system, a portion of an anchoring pile dataset comprising a plurality of customer input and a borehole path;
determining, by the model group, a numerical model of the anchoring pile system;
determining, by the model group, a set of operational loads applied to the anchoring pile system at a load point;
selecting, by an advisory process executing on the computer system, a grout material in response to a set of grout material properties exceeding an operational stress value;
receiving, by an advisory process, a set of outputs from the model group, wherein the set of outputs comprises a stress state of the grout material, a stress limit of a grout interface, or combinations thereof;
iterating, by the advisory process, a grout material from a first grout material to a second grout material in response to a threshold value exceeding at least one of the set of outputs from the model group; and
generating, by the advisory process, a job design in response to the set of outputs exceeding the threshold value.

12. The method of claim 11, further comprising retrieving, by the advisory process, the anchoring pile dataset from a storage computer by an electronic communication method, wherein the anchor pile dataset comprises the plurality of customer inputs, a plurality of sensor data, the borehole path, a material inventory, or combinations thereof.

13. The method of claim 11, further comprising generating, by the model group, the numerical model, by a finite element analysis (FEA) process, from a first set of model inputs, wherein the first set of model inputs comprises a portion of the anchoring pile dataset.

14. The method of claim 11, further comprising generating, by the model group, the set of operational loads by a load point model from a second set of model inputs, wherein the second set of modeling inputs comprises a portion of the anchoring pile dataset.

15. The method of claim 11, further comprising generating, by the model group, the stress limit of the grout interface by a geophysical model from a third set of model inputs, wherein the grout interface is located between the grout material and a formation and wherein the third set of model inputs comprises a portion of the anchoring pile dataset.

16. The method of claim 11, wherein the model group comprising a least one model selected from a group consisting of a pile FEA model, a stress model, a load point model, and a geophysical model.

17. The method of claim 11, wherein the set of outputs from the model group comprises a numerical model of the anchoring pile system, a stress state of a grout material, a stress state of a grout interface, a stress limit of an interface located between the grout material and a formation, a distribution of an operational load to the anchoring pile system, a probability value of a failure of the grout material or a portion of the grout material, or combinations thereof.

18. The method of claim 11, wherein the threshold value comprises a probability value for achieving a job objective, a lifecycle value for a grout, a stress state of the anchor pile system, or combinations thereof.

19. A method of designing an anchoring pile system with a dataset from a drilling operation, comprising:
retrieving, by a design process executing on a first computer, at least one periodic dataset indicative of drilling a borehole;
generating, by the design process, a borehole path comprising a trajectory, a set of formation properties, a description of a borehole environment, or combinations thereof;
generating, by the design process, a model input for a model group;
determining, by the model group executing on a second computer, i) a stress value for an interface of a grout material to a sleeve, ii) a stress value for a grout material, and iii) a stress value for a grout material to a formation;
iterating, by the design process, a grout material from a first grout material to a second grout material in response to a grout stress state exceeding a failure property of at least one of i) the interface of the grout material to the sleeve, ii) the grout material, iii) the interface of the grout material to a formation, iv) or combination thereof; and
generating, by the design process, an anchoring pile design, in response to a threshold of the grout stress state exceeding the failure properties.

20. The method of claim 19, wherein:
the at least one periodic dataset comprises a dataset selected from the group consisting of fluid systems dataset, borehole path dataset, formation properties dataset, or combination thereof; and
wherein the at least one periodic dataset is real-time dataset from a drilling operation.

21. The method of claim 19, further comprising iterating, by the design process, the model input in response to a change in the borehole path or in response to receiving a subsequent periodic dataset indicative of a drilling operation.

22. The method of claim 19, further comprising modifying, by the design process, the anchoring pile design in response to a change in the borehole path.

23. A method of designing an anchoring pile system, comprising:
generating, by a finite element analysis (FEA) process, a numerical model of the anchoring pile system;
generating an anchoring pile design in response to a risk of failure value of one or more grout materials exceeding a risk threshold value; and
wherein the anchoring pile design comprises a grout blend.

24. The method of claim 23, further comprising:
retrieving, by the FEA process, from a database a plurality of customer inputs, a plurality of sensor data, a borehole path, a material inventory, or combinations thereof.

25. The method of claim 23, further comprising:
applying a set of operational loads to a load point on the numerical model;
applying a set of material properties of a grout material to the numerical model; and
determining a risk of failure value for at least one grout location of the grout material on the anchoring pile system.

26. The method of claim 23, further comprising:
drilling a borehole with a drilling assembly;
leaving at least a portion of the drilling assembly in the borehole; and
coupling the drilling assembly to a load point.
